(19) United States
(12) Patent Application Publication
(10) Pub. No.: US 2023/0407921 A1
(43) Pub. Date: Dec. 21, 2023

(54) BEARING ASSEMBLY, IN PARTICULAR FOR AN ELECTRIC MOTOR

(71) Applicant: AKTIEBOLAGET SKF, GOTEBORG (SE)

(72) Inventors: Juergen Barthelme, Grettstadt (DE); Helmut Hauck, Euerbach (DE); Stefanie Seufert, Rothhausen (DE); Hubert Herbst, Gädheim (DE)

(21) Appl. No.: 18/320,041

(22) Filed: May 18, 2023

(30) Foreign Application Priority Data
Jun. 8, 2022 (DE) 102022205789.9

(51) Int. Cl. F16C 33/58; F16C 35/04

(52) U.S. Cl. CPC F16C 33/586; F16C 19/06; F16C 35/045

(57) ABSTRACT

A bearing assembly includes a bearing having a first ring, a second ring rotatably disposed relative to the first ring, and a plurality of rolling elements in a bearing interior defined by the first ring and the second ring, and an electrical insulator on the first ring. The electrical insulator has an annular carrier supporting a layer of electrical insulation, and the layer of electrical insulation is disposed between the first ring and the annular carrier. The annular carrier is formed from at least one strip-shaped carrier blank bent into a ring and having a first end connected to a second end at a joint in a material-bonded and/or interference-fit manner. Also a method of forming the bearing assembly.

### CROSS-REFERENCE

This application claims priority to German patent application no. 10 2022 205 789.9 filed on Jun. 8, 2022, the contents of which are fully incorporated herein by reference.

### TECHNOLOGICAL FIELD

The present invention relates to an insulated bearing assembly which can be used in electric motors, electrical machines, and related equipment.

### BACKGROUND

An electric motor or an electrical machine usually includes a rotatable shaft and a housing receiving the components of the electric motor and the shaft. In order to support the rotatable shaft in the housing, at least one rolling-element bearing with an inner ring and an outer ring is attached between the housing of the motor or the electrical machine and the rotating shaft, wherein usually the inner ring is connected to the shaft such that the inner ring and the shaft rotate together, and the outer ring is connected to the housing such that the outer ring and the housing are rotationally fixed. In operation, an electrical potential difference can arise between the shaft and the housing of the motor or the electrical machine; the electrical potential difference generates an electrical current between the inner ring of the rolling-element bearing and the outer ring.

The electrical current, which then flows through the components of the rolling-element bearing, can damage these components, in particular the rolling elements and the raceways that are attached to the inner and outer ring. In addition, electrical discharges can also generate vibrations.

In order to remedy these disadvantages, it is known to replace the rolling elements of the bearing, which are manufactured from the same steel as the inner and the outer ring, with rolling elements that are manufactured from ceramic. It is then generally referred to as a hybrid rolling-element bearing. However, such a hybrid rolling-element bearing is relatively expensive.

It is also known to attach an insulation layer between bearing ring and housing.

However, in order to apply such an insulation layer between outer ring and housing, and to attach the bearing assembly in the housing such that the bearing assembly and the housing are rotationally fixed, it is necessary that the insulation layer is manufactured in a custom-fit manner. Since such insulation layers are usually manufactured from materials that do not allow such a custom-fit manufacturing and shape retention, a metal ring that must then be manufactured in a custom-fit manner and placed around the insulation layer to maintain the required shape of the insulation layer. This sandwich construction is also very cost-intensive and requires an additional manufacturing step of injecting the insulation material between outer ring and carrier ring.

### SUMMARY

It is therefore an aspect of the present disclosure to provide a bearing assembly that includes electrical insulation and that can be manufactured easily and cost-effectively.

In the following, a bearing assembly is disclosed that includes a bearing having a first ring and a second ring that are disposed rotatably with respect to each other and that define a bearing interior between them. Here the bearing assembly furthermore includes at least one insulation device (electrical insulator) mounted on the first ring of the bearing and an annular carrier and an insulation layer applied on the annular carrier, wherein the insulation layer is disposed between the first ring and the annular carrier and is comprised of an electrically insulating material.

In order to cost-effectively manufacture such a bearing assembly without impairing the electrically insulating properties of the bearing, the annular carrier is manufactured from a strip-shaped carrier blank made of a carrier material bent into a ring, wherein the strip-shaped carrier blank has two abutting edges that are connected to each other in a material-bonded and/or interference-fit manner. The strip-shaped carrier blank preferably has two short edges and two long edges, the abutting edges being realized by the short edges.

Since the annular carrier is manufactured from a strip-shaped carrier blank, various sizes of annular carriers can easily be provided via a corresponding cutting of the carrier material. A simple adaptation to various sizes is thus possible without tubes of different sizes having to be kept in stock or individually manufactured or machined. The material-bonded or interference-fit connection at the two abutting edges in turn ensures that the strip-shaped carrier blank maintains its annular shape and completely encloses the bearing ring.

In contrast to the prior art, in which the metallic ring that covers the insulating layer is manufactured from a tube blank, manufacture from a strip-shaped blank bent into a ring and subsequently connected to itself at its abutting edges makes it possible to provide a simpler and more cost-effective an electrically insulated bearing.

According to one advantageous exemplary embodiment, the insulating layer is formed on the strip-shaped carrier blank, in particular adhered or overmolded onto the strip-shaped carrier blank. This forming-on can be provided both before the round-bending and after the round-bending and makes possible a simple application of the insulation layer onto the strip-shaped carrier blank. Furthermore, it is possible that the insulation later is applied onto the carrier material, i.e., even before the cutting. Thus, for example, a metal plate can be extensively coated with the insulation material, and only in a further manufacturing step the strip-shaped carriers can be cut from the coated plate into the desired size. This also provides a very simple and cost-effective manufacturing method.

According to a further advantageous exemplary embodiment, the annular carrier furthermore has at least one edge bent toward the bearing interior (to form a circular flange). The edge, disposed at least on one side, enables an axially fixed seat of the annular carrier on the bearing ring, and also electrical insulation of the bearing ring on its end sides. In this respect it is advantageous in particular when the edge extends at least partially along an end surface of the first ring. A displacement of the carrier ring in relation to the first bearing ring can thereby be avoided, at least in the axial direction.

Here it is advantageous in particular when the annular carrier has not only one, but rather two bent edges (flanges) that surround the bearing ring in a U-shaped manner. This prevents any relative axial movement between the electrical insulator and the bearing ring.

According to a further advantageous exemplary embodiment, the one abutting edge has a shape complementary to the other abutting edge. A precise mutual alignment of the abutting edges can thus already be achieved during the round-bending, and the round-bending and connecting of the abutting edges can be simplified and accelerated in terms of manufacturing technology, since a precise aligning of the abutting edges with respect to each other is effected automatically.

According to a further advantageous exemplary embodiment, the abutting edges have at least one puzzle-piece-type interference-fit connection via which the abutting edges are connected to each other at least by interference fit. This puzzle-piece-type interference-fit connection makes possible a rapid and custom-fit connecting of the abutting edges so that an annular carrier is formed. In a puzzle-piece-type interference fit, a projection on one of the abutting edges includes a narrow portion and an enlarged portion at the end of the narrow portion that fits into a complementary recess on the other one of the abutting edges. The enlarged portion prevents the projection from being pulled from the recess in the circumferential direction.

Of course, it is also possible that the annular carrier is not comprised of only a single strip-shaped carrier blank, but rather is composed of a plurality of individual pieces that are each connected to one another at their abutting edges. Here, as described above, the abutting edges can be connected to one another in an interference-fit and/or material-bonded manner.

According to a further advantageous exemplary embodiment, the abutting edges are in particular welded to each other. This can also be used in the above-described interference-fit-connected abutting edges as additional securing against an unintentional releasing of the interference-fit connection.

Since the annular carrier must usually still be post-processed in a mechanically precise manner before installing the bearing in the housing, in order, for example, to make possible a press fit against a receiving component, the abutting-edge seams can be simply and cost-effectively post-processed during the post-processing step, in particular ground smooth.

Here it is advantageous in particular when the annular carrier is manufactured from a metallic material, in particular from sheet metal. Metallic materials can be easily and precisely post-processed and thus provide a precise and exact fit into the receiving component.

A further aspect of the present invention relates to a method for the manufacturing of an above-described bearing assembly, with the following steps:
providing a strip-shaped carrier blank, made of a carrier material, with two opposing abutting edges that are disposed on the short sides of the strip-shaped carrier blank, and two long edges,
round-bending the strip-shaped carrier blank into a ring such that the two abutting edges abut against each other, and
joining the abutting edges in a material-bonded and/or interference-fit manner in order to provide an annular carrier.

As also mentioned above, the annular carrier can also be comprised of a plurality of individual strip-shaped carrier blanks that are each connected to each other at their abutting edges in a material-bonded or interference-fit manner.

The providing of a strip-shaped carrier blank made of a carrier material is preferably effected by a cutting of a strip from a metal sheet or cutting to length from a long sheet metal strip, wherein required size differences of a desired end product can be provided simply via sheet metal strips cut to a corresponding size.

According to a further advantageous exemplary embodiment, an insulation layer is applied on the carrier material, wherein the application of the insulation layer onto the carrier material can be effected before forming the strip-shaped carrier blank or after forming the strip-shaped carrier blank. Here it is preferred in particular that the insulation layer is formed-on, in particular overmolded or adhered, to the carrier material. Since the insulation layer is already applied onto the carrier material before the round-bending, a time- and cost-intensive injection of carrier material in an intermediate space between bearing ring and annular carrier can be omitted. The prior application also makes possible a uniform dimensioning of the insulation layer material on the carrier material.

According to a further advantageous exemplary embodiment, at least one of the two long edges of the strip-shaped carrier blank is bent toward the bearing ring so that the bent part is configured to surround, at least partially on its end side, the bearing ring on which the annular carrier is disposed, wherein the bending of the long edge can be effected before or after the round-bending of the carrier blank. As mentioned above, the bent edge makes possible a fixed axial seat of the electrical insulator on the bearing ring so that further attachment means of the electrical insulator onto the bearing ring can be omitted.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic sectional view through a preferred exemplary embodiment of a bearing assembly.

FIGS. 2A and 2B are schematic views of a strip-shaped carrier blank at different processing stages.

FIG. 3 is a schematic Ff

FIG. 5 is a flow chart of an embodiment of a manufacturing method of the bearing assembly.

FIG. 6 is a schematic view of a sheet of material coated with an electrical insulator showing locations at which strip-shaped carrier blanks will be cut.

FIG. 7 is a schematic side elevational view of a strip of material coated with an electrical insulator that can be cut to a desired length to form the strip-shaped carrier blanks.

### DETAILED DESCRIPTION

In the following, identical or functionally equivalent elements are designated by the same reference numbers.

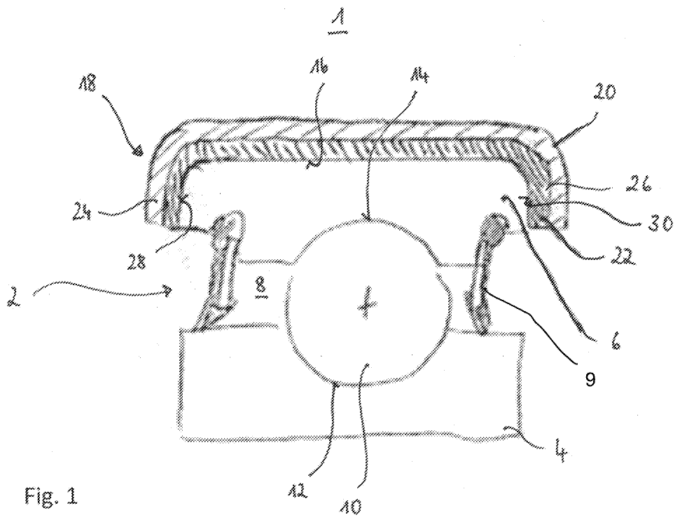

FIG. 1 schematically shows a sectional view through a bearing assembly 1 with a rolling-element bearing 2 as bearing. The rolling-element bearing 2 comprises an inner ring 4 and an outer ring 6 that form a bearing interior 8 between them in which rolling elements 10 are disposed that roll on raceways 12, 14 that are formed on the inner ring 4 and/or outer ring 6. The bearing assembly may also include one or more seals 9 between the outer ring 6 and the inner ring 4.

Furthermore, FIG. 1 shows that an electrical insulator 18 is attached to the outer ring 6 on its outer surface 16. The electrical insulator 18 in turn comprises an annular carrier 20 and an insulation layer 22 that is applied on the annular carrier 20.

Furthermore, FIG. 1 shows that the annular carrier 20 has a U shape with two bent edges 24, 26 that form flanges and extend along end surfaces 28, 30 of the bearing outer ring 6 and that axially attach the annular carrier 20 or the electrical insulator 18 to the bearing outer ring 6.

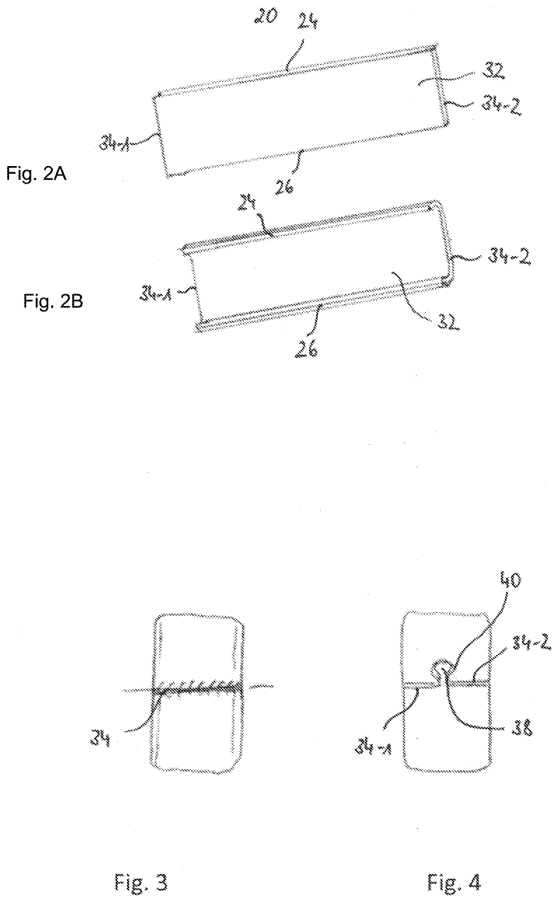

As can be seen in particular from FIGS. 2A and 2B, the annular carrier 20 is manufactured from a strip-shape carrier blank 32, for example, made from a sheet metal strip. Here FIG. 2A shows a strip-shaped carrier ring blank 32 with two short edges 34 that function as abutting edges, and two long edges 24, 26 which, as shown in figure section 2B, are bent toward inside bearing interior 8 in order to achieve the U shape of the annular carrier 20 depicted in FIG. 1. Here the bendings, shown in FIG. 1, of the edges 24, 26 can be introduced before or after a round-bending of the strip-shaped carrier blank 32 for the providing of the annular carrier 20. In FIG. 2, a bending of the edges 24, 26 before the round-bending is depicted. Directions such as “inner” and “outer” used in connection with the strip-shaped carrier blank 32 refer to directions of the annular carrier 20 after it is formed; that is, the edges 24, 26 of the strip-shaped carrier blank 32 will project toward the inside of the annular carrier 20 after it is formed and are thus described as extending toward the inside in connection with FIGS. 2A and 2B.

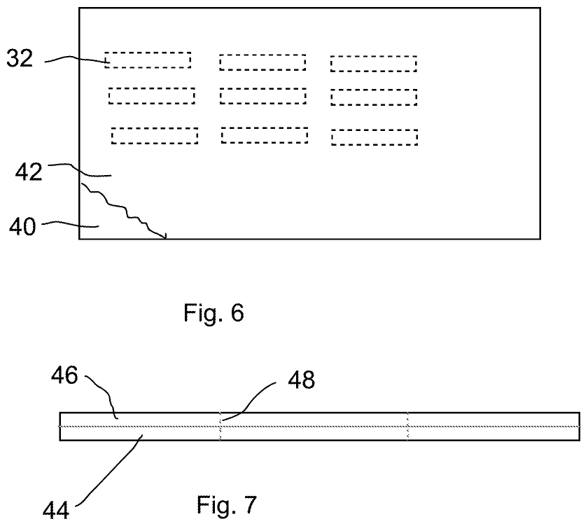

The strip-shaped carrier blank 32 can be cut to size from a sheet of material 40 (FIG. 6) having a large surface area (that is all four sides of the desired strip-shaped carrier blank 32 can be cut from a sheet that is larger than the desired strip-shaped carrier blank 32), or cut to length from a strip of material 44 (FIG. 7) having a width equal to the strip-shaped carrier blank (that is, cut from a strip of sheet metal that already has the final desired strip width), and can thus be individually adapted to the size of the bearing outer ring 6. Here the insulation material 42 of the sheet of material 40 or the insulation material 46 of the strip of material 44 can be applied onto the metal sheet before the cutting (e.g., at locations 48), or alternatively after the cutting so that individually produced sizes of electrical insulators 18 are easily providable.

If the insulation layer 22 is not already applied onto the strip-shaped carrier blank 32 or onto the metal plate, an application of the insulation layer 22 can also be effected after the bending of the edges 24, 26.

If the strip-shaped carrier blank 32 is provided with the insulation layer 22 and has the optional bending of the edge, the strip-shaped carrier blank 32 is bent around the bearing outer ring 6, and its abutting edges 34 are connected to each other in a material-bonded (see FIG. 3) or interference-fit (see FIG. 4) manner.

As FIG. 4 shows in particular, an interference-fit connection can be provided in the form of at least one puzzle-piece-type interference-fit connection 36, in which one of the abutting edges 34-1 has a projection 38, while the other abutting edge 34-2 has an insertion area 39 formed complementary to the projection 38, into which insertion area 39 the projection 38 can be snapped. Of course, other interference fits are also possible.

Of course, it is also possible that material bond and interference fit are combined in order to be able to achieve a particularly secure connection of the abutting edges 34 to each other.

Once the bearing ring 6 is surrounded by the electrical insulator 18 and the annular carrier 20 is connected at its abutting edges 34 in a material-bonded and/or interference-fit manner, a fine machining of the annular carrier 20 can be effected in order to achieve a precise required surface for the press fit of the bearing assembly in a housing. This fine machining of the annular carrier 20 also makes it possible that the bearing outer ring 6 itself need not be fine machined. This also reduces the manufacturing costs, since less effort is needed for a fine machining of the annular carrier 20 than for a fine machining of the rolling-element bearing outer ring 6.

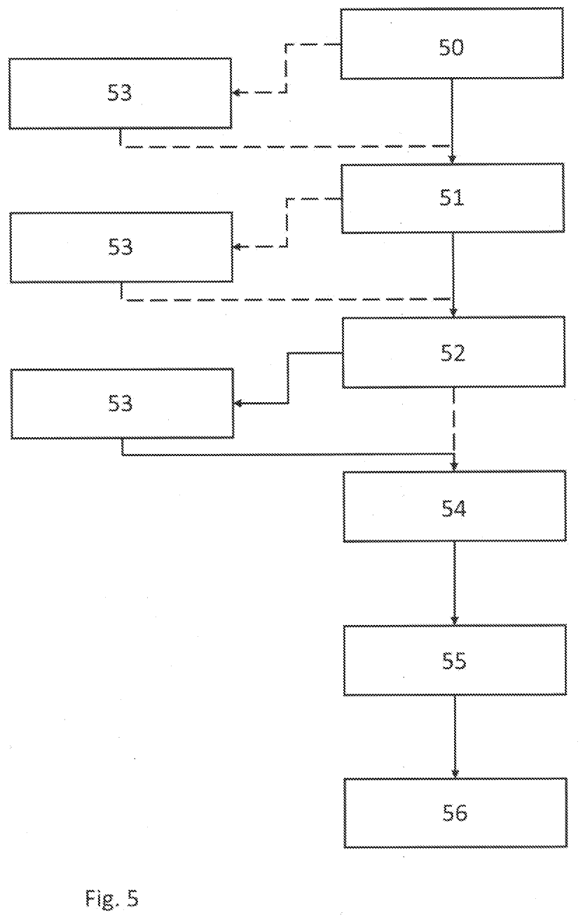

FIG. 5 schematically shows a flow chart of a preferred manufacturing method. In a first step 50, a carrier material is provided in the form of a large-surface metal sheet or a long sheet metal strip. In a step 51, this carrier material is cut, for example, by punching or laser cutting, into the corresponding shape, that is, length and width. Here the different shapes can also be produced for the short sides 34 formed as abutting edges. In particular, during step 51, the corresponding design of an interference fit can be implemented. In a further step 52, a further shaping takes place, in particular a forming and rolling, whereby, for example, a bending of the long edges 24, 26 is achieved.

In a step 53, the application of an insulation layer 22 follows. However, this step 53 can also occur after the providing of a carrier material, i.e. after step 50, after the shaping, i.e., after step 51, or, as depicted here, after the forming or rolling, i.e., step 52. The alternative options are indicated by dashed arrows. The application of the insulation layer 22 is provided in particular by adhering.

After the steps 50-53, the strip-shaped carrier blank 32 is ready for to be mounted on the bearing ring, and in a step 54 it is bent around the bearing ring 6 so that an electrical insulator 18 made of an annular carrier 20 and an insulating layer 22 surrounds the bearing ring 6. In a next step 55, the annular carrier 20 is preferably permanently closed around the bearing outer ring in a close-fitting manner by a material bond or interference fit. Here it is advantageous in particular when the ring is closed at its abutting edges by welding and/or a puzzle-piece-type interference-fit connection. After the closing, in step 56 a mechanical post-processing of the bearing ring 6 occurs with the attached electrical insulator 18. Here in particular the surface of the annular carrier 20 that will form press-fit with a receiving component, for example, a housing, is ground to its precise dimensions, and the raceways 12, 14 of the bearing ring 6 themselves are honed. Of course, further post-processing steps are possible. The finished bearing outer ring 6 with electrical insulator 18 can then be installed in the electric motor.

Due to the manufacturing of the electrical insulator 18 from a strip-shaped carrier blank 32, the widest variety of sizes of bearing outer rings 6 can easily be equipped with the electrical insulator 18. Individual sizes are thereby also easy to manufacture without different tube-type blanks needing to be provided or manufactured for every size of bearing. The material-bonded or interference-fit connecting also does not represent a disadvantage, since the annular carrier usually still must be machined prior to installation. Any protruding weld seams can be easily removed in this step. Overall, the bearing assembly discussed above represents a simple and cost-effective way to electrically insulate a bearing disposed in an electric motor or an electrical machine.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearing assemblies and associated methods.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Bearing assembly
2 Rolling-element bearing
4 Inner ring
6 Outer ring
8 Bearing interior
8 Outer ring
10 Rolling element
12,14 Raceways
16 Outer surface
18 Electrical insulator
20 Annular carrier
22 Insulation layer
24, 26 Bent edges
28, 30 End surfaces
32 Carrier blank
34 Abutting edges
36 Interference-fit connection
38 Projection
39 Insertion area
40 Sheet of material
42 Insulation material
44 Strip of material
46 Insulation material
48 Locations

What is claimed is:

1. A bearing assembly comprising:
a bearing including a first ring, a second ring rotatably disposed relative to the first ring, and a plurality of rolling elements in a bearing interior defined by the first ring and the second ring, and
an electrical insulator on the first ring, the electrical insulator including an annular carrier supporting a layer of electrical insulation,
wherein the layer of electrical insulation is disposed between the first ring and the annular carrier, and
wherein the annular carrier comprises at least one strip-shaped carrier blank bent into a ring and having a first end connected to a second end at a joint in a material-bonded and/or interference-fit manner.

2. The bearing assembly according to claim 1,
wherein the layer of electrical insulation is adhered or overmolded to the strip-shaped carrier blank.

3. The bearing assembly according to claim 1,
wherein the strip-shaped carrier blank has a first longitudinal edge extending from the first end to the second end and a second longitudinal edge extending from the first end to the second end, and
wherein at least one of the first and second longitudinal edges includes a flange extending parallel to the first longitudinal edge.

4. The bearing assembly according to claim 3,
wherein the flange overlies at least one end face of the first ring.

5. The bearing assembly according to claim 4,
wherein the at least one longitudinal edge comprises a first longitudinal edge and a second longitudinal edge, and
wherein the flange of the first longitudinal edge is substantially identical to the flange of the second longitudinal edge.

6. The bearing assembly according to claim 1, wherein the first end is connected to the second end by at least one puzzle-piece-shaped interference-fit connection.

7. The bearing assembly according to claim 1,
wherein the first end is welded to the second end.

8. The bearing assembly according to claim 1,
wherein the at least one strip-shaped carrier blank is formed from sheet metal.

9. The bearing assembly according to claim 1,
wherein the strip-shaped carrier blank is formed from sheet metal,
wherein the layer of electrical insulation is adhered or overmolded to the strip-shaped carrier blank,
wherein the strip-shaped carrier blank has a first longitudinal edge and a second longitudinal edge extending from the first end to the second end, each of the first and second longitudinal edges having a flange extending parallel to the respective longitudinal edge,
wherein the layer of electrical insulation contacts the first ring, and
wherein the flange of the first longitudinal edge overlies a first end face of the first ring and the flange of the second longitudinal edge overlies a second end face of the first ring.

10. The bearing assembly according to claim 9, wherein the first end is connected to the second end by at least one puzzle-piece-shaped interference-fit connection.

11. The bearing assembly according to claim 10,
wherein the first end is welded to the second end.

12. A method comprising:
providing a bearing having a first ring and a second ring,
providing a strip-shaped carrier blank having a first end and a second end and a first longitudinal edge extending from the first end to the second end and a second longitudinal edge extending from the first end to the second end,
attaching a layer of electrically insulating material to the strip-shaped carrier blank,
round-bending the strip-shaped carrier blank along the first ring so that the layer of electrical insulation contacts the first ring and the first end abuts the second end, and
joining the first end to the second end by a material bond and/or an interference fit.

13. The method according to claim 12,
wherein the attaching occurs before the round-bending.

14. The method according to claim 12,
wherein the providing comprises punching or cutting the strip-shaped carrier blank from a sheet of material having a surface area greater than a surface area of the strip-shaped carrier blank.

15. The method according to claim 14,
wherein the sheet of material has a width greater than a width of the strip-shaped carrier blank and a length greater than a length of the strip-shaped carrier blank.

16. The method according to claim 14,
wherein the attaching occurs before the providing.

17. The method according to claim 12,
including bending the first longitudinal edge to form a first flange.
